(19) United States
(12) Patent Application Publication
(10) Pub. No.: US 2015/0185590 A1
(43) Pub. Date: Jul. 2, 2015

(54) FOLDABLE SUBDUED-LIGHTING DEVICE

(71) Applicant: Te-Fan Ho, Taipei City (TW)

(72) Inventor: Nai-Chi SHIN, Hsinchu City (TW)

(21) Appl. No.: 14/521,899

(22) Filed: Oct. 23, 2014

(30) Foreign Application Priority Data
Dec. 31, 2013 (TW) 102224918

(51) Int. Cl. G03B 15/06

(52) U.S. Cl. CPC G03B 15/06

(57) ABSTRACT

A foldable subdued-lighting device is provided, comprising a base pedestal, and on an upper surface of the base pedestal is an assembly part. The assembly part is covered with a soft subdued-lighting mask, and there are a plurality of light-guiding refraction protrusions which surround and are disposed on an inner surface of the soft subdued-lighting mask. When the proposed device is applied to a lamp, the light emitted from the lamp passes through the light-guiding refraction protrusions, such that the original light is spread and diffused to become a subdued light. The proposed device is advantageous of generating a subdued light by using the light-guiding refraction protrusions to refract the light emitted from the lamp, and also generating light with high intensity by folding the soft subdued-lighting mask itself such that the transparency of the soft subdued-lighting mask is adjusted.

This application claims priority for Taiwan patent application no. 102224918 filed at Dec. 31, 2013, the content of which is incorporated by reference in its entirely.

### BACKGROUND OF THE INVENTION

1. Field of the Invention

The present invention is related to a photography lighting device, and more particularly to a foldable subdued-lighting device.

2. Description of the Prior Art

In the field of photography nowadays, flash lights are very commonly used for providing enough ambient light. However, it shall be noticed that, the photos shot in this way are usually too stiff, especially when the flash lights are applied to, for example portrait photography or model shooting. The lines of the character will become too sharp, and the skin color itself can not be as delicate as using the day light as the light source. Therefore, in order to make the lines or the skin color of the character being shot much softer and more natural, a subdued-lighting device is needed to be provided at the front of the flash light. As such, the light emitted from the flash light will be scattered because of the special material of the subdued-lighting device, and be not that stiff as before. Besides, by involving the subdued-lighting device with the traditional flash light, the rigidness and sharpness of the photos being shot can also be avoided. Therefore, any photographer can make photos with perfect light condition regardless of being indoor or outdoor, and present the best of the pictures.

Nevertheless, there are still problems arisen because the material of the subdued-lighting device is mostly anti-glare so as to shelter part of the light emitted from the flash light, thereby softening the light beams. Moreover, the crust of the conventional subdued-lighting device is made of hard-case, so its transparency cannot be adjusted by folding the case or the crust itself. As such, the intensity of the light emitted from the flash light can't be modified as well. Furthermore, since the hard case of the conventional subdued-lighting device lacks of flexibility, it is very likely to be dropped or fallen off easily in use while being not used properly.

On account of all, it should be obvious that there is indeed an urgent need for the professionals in the field for a new subdued-lighting device to be developed which must be foldable so as to solve the above-mentioned problems occurring in the prior design.

### SUMMARY OF THE INVENTION

In order to overcome the above-mentioned disadvantages, one major objective in accordance with the present invention is provided for a foldable subdued-lighting device, which is aimed at generating a soft and subdued light by disposing a plurality of light-guiding refraction protrusions inside a soft subdued-lighting mask to refract the light emitted from the lamp.

And still another major objective in accordance with the present invention is provided for a foldable subdued-lighting device, which is aimed at being able to generate light output having higher intensity when folding the soft subdued-lighting mask itself such that the transparency of the soft subdued-lighting mask is adjusted.

And yet another major objective in accordance with the present invention is provided for a foldable subdued-lighting device, which merely utilizes a simple structure to achieve the effects of generating soft and subdued lights. Since the complexity of the structure is quite low, any possibility that technical hitch or failures may happen can thus be dramatically reduced as well.

For achieving the above mentioned objectives, the present invention provides a foldable subdued-lighting device, comprising:

(1) a base pedestal, comprising an assembly part on an upper surface of the base pedestal; and

(2) a soft subdued-lighting mask, which covers the assembly part, and a plurality of light-guiding refraction protrusions are configured to surround and disposed sidelong on an inner surface of the soft subdued-lighting mask.

As a result, while compared to the prior arts, the proposed foldable subdued-lighting device of the present invention is characterized by:

(1) the proposed foldable subdued-lighting device is able to generate a soft and subdued light by using the plurality of light-guiding refraction protrusions of the soft subdued-lighting mask to refract the light emitted from the lamp.

(2) the proposed foldable subdued-lighting device is able to generate light output having higher intensity when folding the soft subdued-lighting mask itself such that the transparency of the soft subdued-lighting mask is reduced.

(3) the proposed foldable subdued-lighting device merely needs to utilize a simple structure to achieve the effects of generating soft and subdued lights. Since the complexity of the structure is quite low, any possibility that technical hitch or failures may happen can thus be dramatically reduced as well.

These and other objectives of the present invention will become obvious to those of ordinary skill in the art after reading the following detailed description of preferred embodiments.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings:

FIG. 1 shows a solid view of the foldable subdued-lighting device in accordance with one embodiment of the present invention.

FIG. 2 shows a cross-sectional view of the foldable subdued-lighting device in accordance with one embodiment of the present invention.

FIG. 3 shows a structural view when the foldable subdued-lighting device is applied to a lamp in accordance with one embodiment of the present invention

FIG. 4 shows a solid view of the foldable subdued-lighting device in accordance with another embodiment of the present invention.

### DESCRIPTION OF THE PREFERRED EMBODIMENTS

Reference will now be made in detail to the preferred embodiments of the present invention, examples of which are illustrated in the accompanying drawings. Wherever possible, the same reference numbers are used in the drawings and the description to refer to the same or like parts.

The embodiments described below are illustrated to demonstrate the technical contents and characteristics of the present invention and to enable the persons skilled in the art to understand, make, and use the present invention. However, it shall be noticed that, it is not intended to limit the scope of the present invention. Therefore, any equivalent modification or variation according to the spirit of the present invention is to be also included within the scope of the present invention.

The present invention discloses a foldable subdued-lighting device, which is aimed to provide soft subdued light by refracting an incident light. Moreover, the proposed subdued-lighting device is also able to generate light with higher intensity when folding the soft subdued-lighting mask itself such that the transparency of the soft subdued-lighting mask is adjusted.

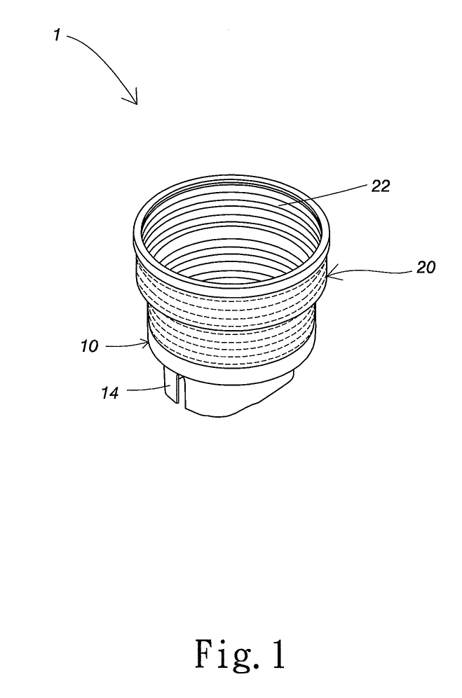

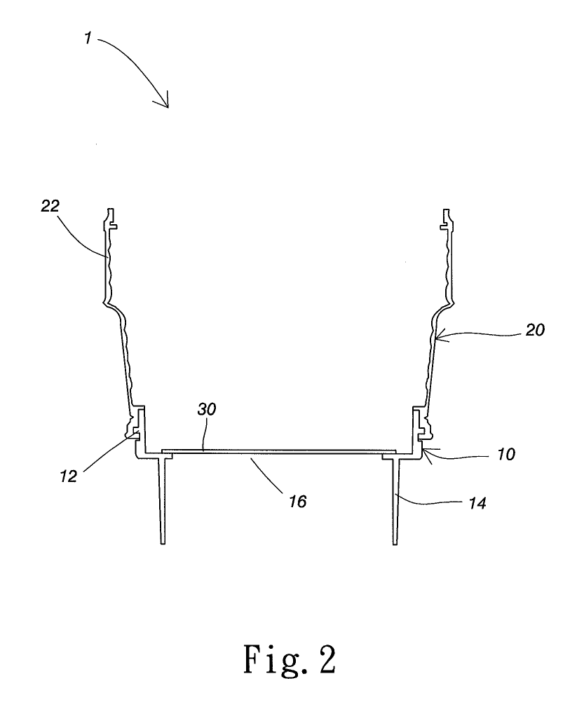

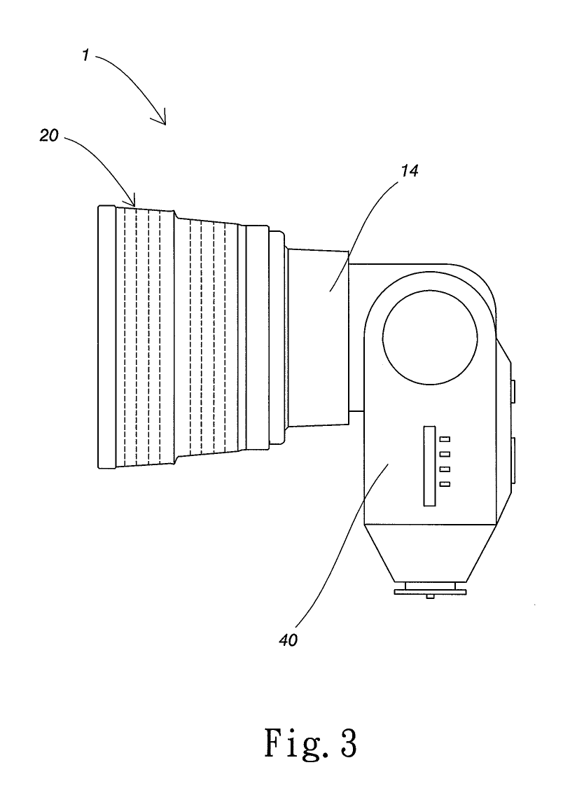

In order to explain the structure of the proposed device of the present invention, please refer to FIG. 1 and FIG. 2, which individually shows a solid and a cross sectional view of the foldable subdued-lighting device in accordance with one embodiment of the present invention. As shown in FIGS. 1 and 2, the foldable subdued-lighting device 1 comprises a base pedestal 10, and an assembly part 12 is disposed on an upper surface of the base pedestal 10. According to one embodiment of the present invention, the assembly part 12 protrudes from the upper surface of the base pedestal 10, such that a soft subdued-lighting mask 20 is able to cover and surround upon the assembly part 12. In one embodiment, the soft subdued-lighting mask 20 is for example a silicon subdued-lighting mask or a rubber subdued-lighting mask, and is designed to be anti-glare for absorbing and softening incident lights. Furthermore, the soft subdued-lighting mask 20 expends from where it is closed to the assembly part 12 to outwards, such that the soft subdued-lighting mask 20 forms stairs-like. And, a plurality of light-guiding refraction protrusions 22 are further configured to surround and disposed sidelong on an inner surface of the soft subdued- lighting mask 20. According to the embodiment of the present invention, a thickness of the soft subdued-lighting mask 20 is 0.5˜1 mm, and a thickness of each of the plurality of light-guiding refraction protrusions 22 is 1˜1.5 mm. To be more specific, the optimum thickness of the soft subdued-lighting mask 20 is around 0.8 mm, and the optimum thickness of each of the plurality of light-guiding refraction protrusions 22 is around 1.2 mm. As a result, when there is an incident light, the plurality of light-guiding refraction protrusions 22 can still work well to refract the incident light whether or not the soft subdued-lighting mask 20 is transparent, and a soft subdued light can be generated through being refracted by the soft subdued-lighting mask 20. Moreover, a connecting part 14 is disposed and extended from a lower surface of the base pedestal 10, such that the base pedestal 10 is applicable to a lamp through the connecting part 14 as shown in FIG. 3. A transparent part 16 is further disposed on the base pedestal 10 and the location is corresponding to where the connecting part 14 is. Therefore, the light emitted from the lamp is able to pass through the transparent part 16. According to one embodiment of the present invention, the transparent part 16 may further comprise a spectral filter 30 so as to change the colour of the light emitted from the lamp.

Please refer to FIG. 2 and FIG. 3, which shows a structural view when the foldable subdued-lighting device is applied to a lamp in accordance with one embodiment of the present invention. In details, FIG. 3 specifies how the foldable subdued-lighting device 1 of the present invention is applicable to a lamp through the connecting part 14. In FIG. 3 the lamp is shown as a flash light 40, and the light emitted from the flash light 40 will soon pass through the plurality of light-guiding refraction protrusions 22 of the soft subdued-lighting mask 20 and be softened and subdued. In this embodiment, since the optimum thickness of the soft subdued-lighting mask 20 is 0.8 mm, and the optimum thickness of each of the plurality of light-guiding refraction protrusions 22 is 1.2 mm, the light emitted from the flash light 40 can thus be refracted and transferred into an optimum subdued light. As a result, by doing so, no matter a photographer is taking photo shoots indoor or outdoor, an image that is characterized with the best light condition can be successfully obtained.

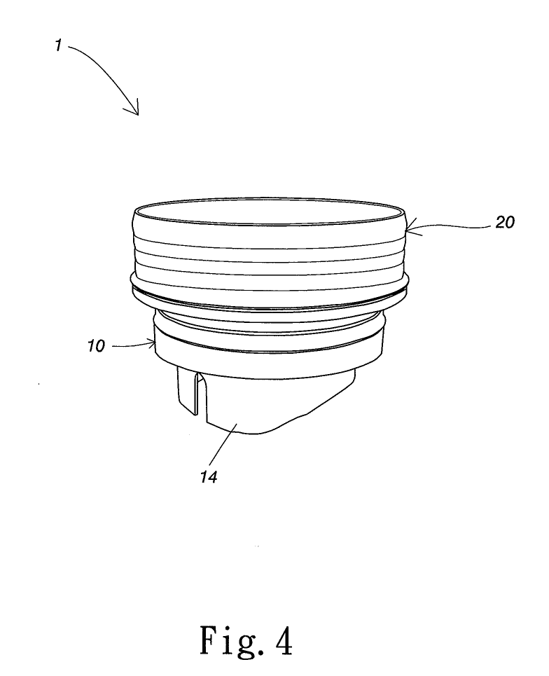

Please refer to FIG. 4, which shows a solid view of the foldable subdued-lighting device in accordance with another embodiment of the present invention. As shown in FIG. 4, since the soft subdued-lighting mask 20 of the present invention is designed to be flexible, folding the soft subdued-lighting mask 20 itself is able to modify the transparency of the soft subdued-lighting mask 20. For example, if the light output is expected to have higher intensity, a user can directly fold that soft subdued-lighting mask 20 such that the soft subdued-lighting mask 20 is bended and retrieved on the base pedestal 10. Since the transparency of the soft subdued-lighting mask 20 after being folded is decreased, more light emitted from the lamp can be remained and kept in the soft subdued-lighting mask 20 to form stronger light source. As such, when there is light output, a higher intensity of the light can thus be obtained. On account of this, it is obvious that, the proposed device of the present invention is able to adjust intensity of the light output by folding the soft subdued-lighting mask 20 and changing its transparency, thereby increasing the mobility and flexibility of the present invention while in use.

To sum up, it is believed that the proposed foldable subdued-lighting device of the present invention is advantageous of generating a soft and subdued light by using the plurality of light-guiding refraction protrusions of the soft subdued-lighting mask to refract the light emitted from the lamp. On the other hand, the proposed device of the present invention is also advantageous of being able to generate light output with higher intensity when folding the soft subdued-lighting mask itself such that the transparency of the soft subdued-lighting mask is adjusted. Therefore, it is self evident that the present invention merely needs to utilize a simple structure to achieve the effects of generating soft and subdued lights. Since the complexity of the structure is quite low, any possibility that technical hitch or failures may happen can thus be dramatically reduced as well.

It will be apparent to those skilled in the art that various modifications and variations can be made to the present invention without departing from the scope or spirit of the invention. In view of the foregoing, it is intended that the present invention cover modifications and variations of this invention provided they fall within the scope of the invention and its equivalent.

What is claimed is:

1. A foldable subdued-lighting device, comprising:
a base pedestal, comprising an assembly part on an upper surface of said base pedestal; and
a soft subdued-lighting mask, which covers said assembly part, and a plurality of light-guiding refraction protrusions are configured to surround and disposed sidelong on an inner surface of said soft subdued-lighting mask.

2. The foldable subdued-lighting device of claim 1, wherein said soft subdued-lighting mask expends from where it is closed to said assembly part to outwards, such that said soft subdued-lighting mask forms stairs-like.

3. The foldable subdued-lighting device of claim 1, wherein a thickness of said soft subdued-lighting mask is 0.5˜1 mm, and a thickness of each of said plurality of light-guiding refraction protrusions is 1˜1.5 mm.

4. The foldable subdued-lighting device of claim 1, wherein said soft subdued-lighting mask is a silicon subdued-lighting mask or a rubber subdued-lighting mask.

5. The foldable subdued-lighting device of claim 1, further comprising a connecting part, which is disposed and extended from a lower surface of said base pedestal, such that said base pedestal is applicable to a lamp through said connecting part.

6. The foldable subdued-lighting device of claim 5, further comprising a transparent part disposed on said base pedestal corresponding to said connecting part, such that a light emitted from said lamp is able to pass through said transparent part.

7. The foldable subdued-lighting device of claim 6, wherein said transparent part further comprises a spectral filter.

8. The foldable subdued-lighting device of claim 1, wherein said assembly part protrudes from said upper surface of said base pedestal, such that said soft subdued-lighting mask covers and surrounds upon said assembly part.

9. The foldable subdued-lighting device of claim 1, wherein said soft subdued-lighting mask is foldable so as to adjust transparency of said soft subdued-lighting mask.
